(19) United States
(12) Patent Application Publication
(10) Pub. No.: US 2013/0019523 A1
(43) Pub. Date: Jan. 24, 2013

(54) Paper Web Assemblies And Their Uses

(71) Applicant: Murray Leslie Cruickshank, Auckland (NZ)

(72) Inventor: Murray Leslie Cruickshank, Auckland (NZ)

(73) Assignee: Ecocover International Limited, Central Hong Kong (CN)

(21) Appl. No.: 13/517,003

(22) PCT Filed: Dec. 8, 2010
(86) PCT No.: PCT/NZ2010/000245

§ 371 Date: Oct. 1, 2012

(51) Int. Cl. A01G 13/02; B32B 3/02; B32B 29/02

(52) U.S. Cl. 47/9; 442/1; 442/412; 442/297; 428/57; 428/58; 428/535

(57) ABSTRACT

A pliable sheet material suitable as a ground cover, said material comprising or including a core region of a bonded matrix of paper shreds, a kraft paper liner on at least one side of the core region bonded to the matrix, and a kraft paper including sheet assembly that includes a tear resistant material selected from a mesh material, woven material or non-woven material and which sheet assembly is bonded to the matrix of the core region on the other side.

The present invention relates to paper web assemblies and their uses.

The present invention also relates to pliable sheet material having a wet strength. More particularly it relates to ground covering sheeting and/or protective sheeting.

In New Zealand patent specification 270410 (Stevens) and WO01/89823 (PCT/NZ01/00093) [the whole contents of which are included by reference] there is disclosed pliable, sheet material. Such sheet material is able to be used as a mulch or seed mat, or otherwise as a covering, and is in the form of a core matrix of shreds of paper adhesively fixed to a liner on both sides.

Preferably the shreds of paper are adhesively affixed both amongst themselves and to the liner(s) by, for example, a PVA adhesive or starch based adhesive. Preferably the liners are each a ply of kraft paper. Examples include a kraft paper from 15 GSM to 50 GSM (most preferably about 40 GSM). Alternatives to a PVA type adhesive are discussed.

The adhesive may have inclusions such as a fertiliser, biocides, colourings, herbicides, insecticides, non-reflectants, reflectants, etc each of which can add to the functionality of the resulted pliable sheet material.

Experience has revealed that a sheet material of for example 0.5 to 5 mm thickness (preferably from 1 to 2 mm thick) and from 1 mm to 5 m in width (preferably about 2 metres in width), when laid out as ground cover, is effective in maintaining the integrity of the underlying soil, allowing the moisture penetration, etc.

The moisture penetration is enabled because the adhesive need only be applied to the shreds of paper and thus not every part of the inner surface of each sheet ply is adhesively covered. Thus there are zones where there is only the paper fibres.

This facilitates moisture transfer from one side of that pliable sheet material to the other.

The difficulty arises however in affixing one edge region of such a pliable sheet to another edge region.

Where there is no overlay of one edge region with another, mere stitching together or stapling together can prove insufficient against tearing when exposed to the wind. This is particularly so owing to the integrity of the paper of the liner on each side being compromised when wet.

Even with some degree of overlapping, and with stitching or stabling, the vulnerability of the uppermost exposed edge region to wind remains. More so again when wet.

The present invention recognises an advantage in applying or having applied a layer able to be used to interconnect between layed out rolls of such a paper based assembly or a modification of it. Preferably the applied material itself and/or any underlying adhesive is not sufficiently coextensive (if water impervious) and/or is not water impenetrable (if coextensive) as to prevent moisture passage into and through the paper assembly or its modification.

Optionally the applied material can be an overlay (e.g. to lie above or below the paper assembly when used on the ground) or within the paper assembly or a modification.

The invention also recognises advantages in use for a pliable sheet material of a kind disclosed in either or both the aforementioned patent specifications, the full content of which is here included by way of reference, when at least one outside surface has been coated to enhance a functionality or utility.

The invention also recognises as an object enhanced wind resistance for a largely paper based horticultural ground covering i.e. able when wet or when windy, stitched or stapled together, able to resist tearing.

In an aspect the invention is a pliable sheet material suitable as a ground cover, said material comprising or including

a core region at least primarily of a matrix of paper shreds,

a paper sheet as a liner, or paper including sheet assembly as a liner, adhered to one side of the core region, and

a paper sheet, as a liner, or paper including sheet assembly, adhered to the other side of the core region;

wherein there is present at least one sheet or strip of a mesh material, non-woven material or woven material able to confer tear resistance:

(i) as part of a paper including sheet assembly on at least one side of the core region which includes

(ii) embedded as part of the core region, or

(iii) both (i) and (ii).

Preferably said tear resistant material is externally adhered to a paper sheet that itself is adhered to a side of the core region.

Preferably there is a paper including sheet assembly that has said tear resistant material interposed between the paper sheet and the core region and adhered to both.

Preferably the tear resistant material is substantially coextensive with the paper of the sheet assembly.

Preferably said core region of paper shreds is at least to some extent adhesively bonded, shred to shred, to provide a water porous matrix (e.g. as in WO01/89823).

In another aspect the invention is a pliable sheet material suitable as a ground cover, said material comprising or including

a core region of a bonded matrix of paper shreds,

a kraft paper liner on at least one side of the core region bonded to the matrix, and

a kraft paper including sheet assembly that includes a tear resistant material selected from a mesh material, a woven material or non-woven sheet material and which sheet assembly is bonded to the matrix of the core region on the other side.

Preferably the kraft paper including sheet assembly is bonded by the kraft paper to said matrix so that the tear resistant (sheet) material is to the exterior.

Preferably the core region is in the range of from 200 gsm to 900 gsm reliant on shreds of paper of from 65 to 85 gsm.

Preferably the kraft paper of one liner and in the sheet assembly of the other liner is from 30 to 100 gsm.

Preferably said kraft paper is in the range of from 40 to 50 gsm.

Preferably said mesh, woven or non-woven tear resistant material is of hessian.

Preferably said hessian is from 6 to 8 ounces/square yard hessian.

In an aspect the invention consists in the use of a tear resistant material as an internally and/or externally applied and adhered layer of and/or to a paper based sheet assembly having between spaced paper sheets a shredded paper material matrix.

In another aspect the invention is a pliable sheet material such as disclosed and/or claimed in either or both the aforementioned patent specifications and which has subsequently had at least one layer of a material (e.g. bentonite, snail repellent, paint, ink, etc) or sheet material (e.g. tear resistant mesh or woven material) affixed externally thereof.

In still a further aspect the invention is a pliable sheet material, as or for a horticultural ground covering, of paper shreds, at least to some extent mutually bonded, between water porous paper or paper including liners; wherein at least one liner has at least one layer of a coating material over and/or at least one layer of sheet material affixed externally thereof, such coating and/or layer to improve, or having the capability to improve, tear resistance and/or reflectivity to horticultural plants.

In another aspect the invention is mulch, seed or like mat comprising or including

a first ply of paper,

a second ply of paper,

a matrix of paper shreds interposed between, yet adhering to, each of said plies, and

a mesh or woven material adhered to the outer face of one of said plies of paper.

Preferably the mesh or woven material is biodegradable.

Preferably (A) the mesh or woven material, and (B) the adhesive (or the patterning of the adhesive) affixing the mesh or woven material to the paper, allows water passage.

In an aspect the invention is a ground covering of at least substantially juxtaposed lengths of water penetrable webs of a pliable sheet material, each web edgewise being attached (with or without any overlap) to a juxtaposed web;

wherein each web has a wet strength providing layer of a mesh or woven material affixed externally of and to a paper layer;

and wherein the, or a, paper layer of the pliable sheet material, as a matrix flanking layer, has a matrix of paper shreds, or other shred-like material, adhered thereto or adhered both internally thereto and to another matrix flanking layer.

Preferably the mesh or woven material is, for example, hessian or a plastics material.

Preferably the mesh or woven material is coextensive with the paper layer(s).

Preferably the mesh or woven material has been affixed subsequently to the matrix of shreds being interposed and adhered to spaced flanking layers.

As used herein the term “and/or” means “and” or “or”. In some circumstances it can mean both.

As used herein the term “(s)” following a noun means one or both of the singular or plural forms.

As used herein “tear resistant” and variations of it can include enhanced performance when wet over variants devoid the mesh, woven or non-woven reinforcement layer and thus improved wind resistance when layed out.

Reference herein to a “mesh” or “woven” material has no restriction as to the manner by which that layer or web of material is manufactured.

If a woven material, preferably it is woven from a fibrous material (whether of natural or synthetic origin). Examples include a jute derived fibre woven to provide a hessian (preferably with a low oil content). Advantages seen for the use of such a hessian like material as a ground cover is that it is disliked by some species of pests e.g. rabbits, pukekos, snails, etc. Thus emergent plants through such ground cover tend to be attacked less by any such species. Likewise any seed content that may be included in the shred material matrix is less likely to be challenged by a pukeko.

Other woven material can be any suitable fabric.

A non-natural material is a perforate biodegradable plastics film (e.g. as a mesh) or a moulded or woven fibres or expanded film of a synthetic (preferably biodegradable) plastics material. For example, nylon mesh.

Also, or instead, envisaged is the provision of a partial or intermittent coating of particular material whether powder, granulated, or otherwise. Examples include such minerals as bentonite that can, as a particle, be affixed to the external surface of paper. Similarly some snail repellent materials (e.g. of a powder or granule or wax-like particulate material having a repelling agent for such species).

The present invention recognises that the layer is preferably able to be used to resist wind loading and tear through of stitching, stapling or taping even when the overall assemblies, when layed out, may be exposed to wind and in wet conditions. For this reason therefore, and to ensure porosity for moisture passage, preferably the mesh or woven form is preferred to a straight film form or expanded film form that may have some semblance of water permeability.

Optionally the adhesive can be a material not resistant to water passage (for example, a PVA or like glue system (preferably with cross linking) but of a low solids content) so that, even when applied by a non-profiled roller or as a spray, the adhesive can, in time, allow water to pass through the overall assembly notwithstanding the adhesive layer.

In other forms a profiled roller or intermittent spray arrangement can be used so that there are areas without adhesive that are conducive to moisture movement through the assembly even though there may be other areas where the adhesive is less conducive.

Similarly the layer material need not be fully or consistently mesh like or woven. Other hybrid structures are capable of use as a reinforcement at or adjacent or beyond edge regions. Such reinforcement layers can be strips transversely of a web axis so as to provide anchoring points for stitching. Preferably however they extend longitudedly of, and transversely of, the full underlying paper based or including assembly.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

A preferred form of the present invention can now be described by the accompanying drawings in which

FIG. 1 shows in plan ground cover showing adjacent butting or partly overlapping edge regions of an assembly of the present invention and showing the same stitched together or stapled together to resist wind uplift,

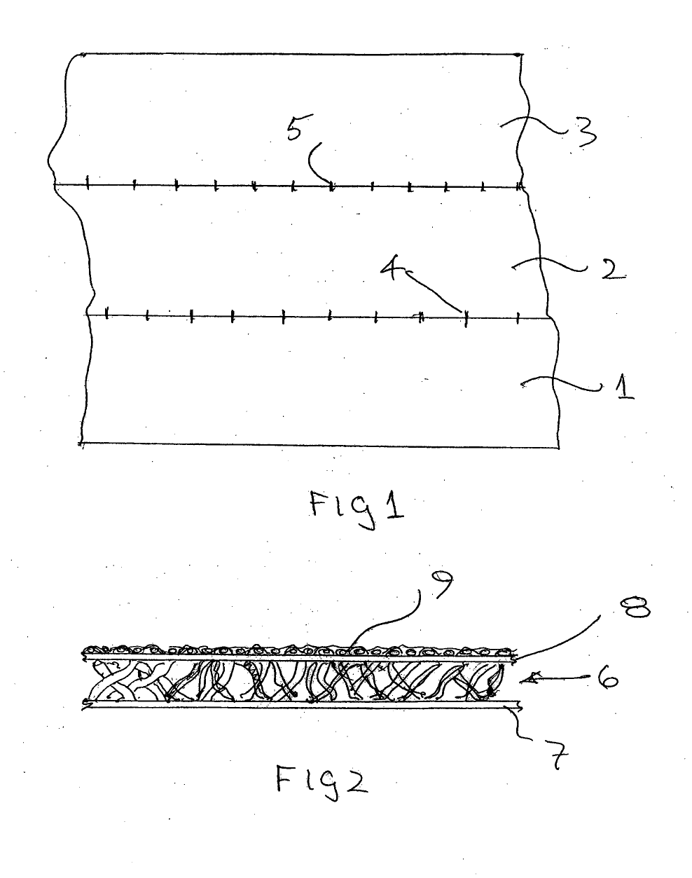

FIG. 2 is by way of example only a cross section of a preferred assembly of the present invention, wherein the add on layer, post manufacture of the paper based assembly (i.e. of two paper outers and a central matrix of shredded paper), is hessian of a low oil content and adhesively affixed to the outer surface of the kraft paper by suitable low solids but cross linked PVA adhesive system,

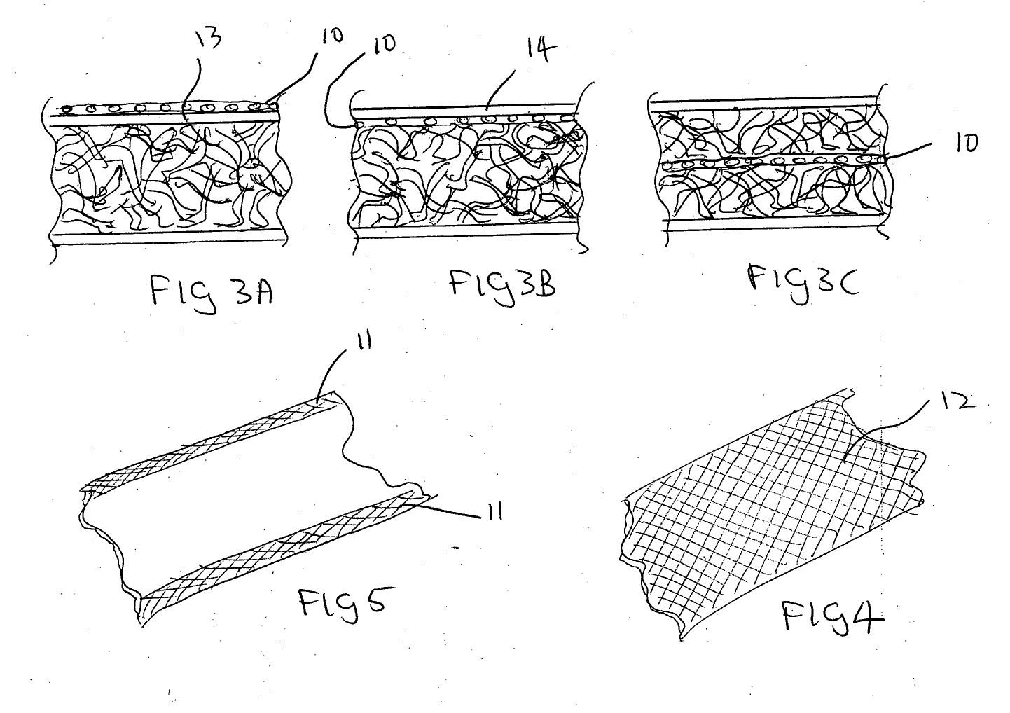

FIG. 3A is a similar cross section to that of FIG. 2,

FIG. 3B is a variation of the arrangement of FIG. 3A with the tear resistant material, as part of a paper sheet including assembly but internally of the paper sheet is interposed between, but adhered to, the paper shred matrix and to the overlying paper sheet,

FIG. 3C is another variation to FIGS. 3A and 3B where the tear resistant material is not adhered as part of a paper sheeting including assembly but rather is disposed within the core of shred material,

FIG. 4 is a plan view of a preferred web of pliable sheet material in accordance with the present invention where the tear resistant layer is external and is coextensive with the width and length of the web (preferably as its unrolled), and

FIG. 5 shows how each edge region continuously (an alternative is discontinuously) is provided with a tear resistant reinforcement (whether as an applied self adhesive tape or not) thus better enabling stapling, stitching etc and the like adjacent sheets one to another in an at least party overlapped manner or near abutting condition.

In the preferred form of the present invention each of the webs can have a staple or stitch line [4 between webs 1 and 2 and 5 between webs 2 and 3] holding that edge region to the edge region of a butted or overlapped or underlapped edge region of the juxtaposed web.

FIG. 2 shows a lower kraft paper ply 7, an upper kraft paper ply 8, an interposed matrix 6 of paper shred material as referred to in the aforementioned patent specification, the assembly being held together by a suitable adhesive (e.g. PVA) which hold shreds together as well as to the flanking paper layers 7 and 8. Shown adhered to the exterior of one of the paper layers (preferably that to be uttermost paper 8 in use) is a hessian layer 9 which is a woven material of jute fibres.

Persons skilled in the art will appreciate how variations can occur.

The preferred manufacturing process is that the hessian material to adhesive coated paper layer 8 after the final manufacturing stage of the remainder of the assembly (i.e. that of 6, 7 and 8).

Shown in FIGS. 3A through 3C is a tear resistant layer 10 in sequence (a) externally of the paper sheet of a paper sheet including assembly as a liner, (b) internally of a paper sheet of a paper sheet assembly as a liner and (c) interposed between paper sheet liners but as part of the core of at least in part mutually adhered paper shreds.

FIG. 5 shows the option of edge reinforcement by strips (continuous strips shown on both flanks) as 11. Persons skilled in the art will appreciate how this can be a viable alternative to the coextensive or near coextensive arrangement shown with the tear resistant material 12 in the embodiment of FIG. 4.

An example of a preferred construction is one formed in a method as shown in FIGS. 3A or 3B. However it could be a hybrid of both 3A and 3B (i.e. with the mesh on both flanks) or a hybrid of the embodiment of FIG. 3C with one or other or both of the embodiments of FIGS. 3A and 3B.

The process of manufacture is most easy for an embodiment as shown in FIG. 3A since there a manufacturing process as disclosed in WO01/89823 can be used and the tear resistant layer of hessian or other sheet (mesh, non-woven [e.g. film] or woven) material 10 merely adhered as a post production extra manufacturing step.

In the arrangement as shown in FIGS. 3A and 3B, instead there can be some pre-lamination of the tear resistant layer 10 to the paper sheet 13 or 14 respectively and thereafter use of that assembled web much as disclosed for a single web of paper in the aforementioned WO01/89823.

By way of example of an arrangement as shown in FIG. 3A or 3B, preferably a suitable material is as follows:

A paper shred medium at least substantially mutually adhered with a suitable adhesive (e.g. PVA) provides a weight of about 200 gsm to 900 gsm using paper shreds derived from paper of from 65 to 85 gsm.

The paper of the liner or paper including assembly, as a liner, is from 30 to 100 gsm (more preferably 40 to 50 gsm) and is of the same kraft paper for both.

A preferred tear resistant material is 6 to 8 oz/square yard open weave hessian with a low oil content adhered to the paper shred or the kraft paper or both by a PVA adhesive.

Alternatives to the open weave hessian include a plastic mesh, a woven product (e.g. fabric) of other natural or synthetic fibre, a cotton mesh or a cotton woven product. Other tear resistant material includes perforate or un-perforate plastics film.

In some aspects of the present invention preferably the tear resistant layer [whether uppermost or underneath] can be coated with a reflectant or itself provide reflectivity. By way of example, a perforate or other sheet material [such as the horticultural films of SONOCO UV reflective films] can be used in order to enhance reflectivity.

Likewise coatings able to be sprayed on (e.g. a high density UV reflective paint) in order to reflect light of a desired horticultural spectrum.

The pliable sheet material of the present invention can also be used to carry seeds and/or fertilising elements [e.g. embedded seeds or other underlying seeds].

1-24. (canceled)

25. A pliable sheet material suitable as a ground cover, said material comprising:
a core region at least primarily comprised of a matrix of paper shreds;
a paper sheet as a liner, or paper including sheet assembly as a liner, adhered to one side of the core region;
a paper sheet as a liner, or paper including sheet assembly as a liner, adhered to the other side of the core region; and
at least one sheet or strip of a mesh material, non-woven material or woven material having tear resistance selected from the group consisting of (i) as part of the paper including sheet assembly on at least one side of the core region which includes; (ii) embedded as part of the core region; a combination thereof.

26. A pliable sheet material as set forth in claim 25, wherein said tear resistant material is externally adhered to a paper sheet that itself is adhered to a side of the core region.

27. A pliable sheet material as set forth in claim 25, wherein there is a paper including sheet assembly that has said tear resistant material interposed between the paper sheet and the core region and adhered to both.

28. A pliable sheet material as claimed in claim 26, wherein the tear resistant material is substantially coextensive with the paper of the sheet assembly.

29. A pliable sheet material as claimed in claim 25, wherein said core region of paper shreds is at least to some extent adhesively bonded, shred to shred, to provide a water porous matrix.

30. A pliable sheet material suitable as a ground cover, said material comprising or including
a core region of a bonded matrix of paper shreds;
a kraft paper liner on at least one side of the core region bonded to the matrix; and
a kraft paper including sheet assembly that includes a tear resistant material selected from a mesh material, woven material or non-woven material and which sheet assembly is bonded to the matrix of the core region on the other side.

31. A pliable sheet material as claimed in claim 30, wherein the kraft paper including sheet assembly is bonded by the kraft paper to said matrix so that the tear resistant mesh, woven or non-woven sheet material is to the exterior.

32. A pliable sheet material as claimed in claim 25, wherein the core region is in the range of from 200 gsm to 900 gsm reliant on shreds of paper of from 65 to 85 gsm.

33. A pliable sheet material of claim 30, wherein the kraft paper of one liner and in the sheet assembly of the other liner is from 30 to 100 gsm.

34. A pliable sheet material of claim 33, wherein said kraft paper is in the range of from 40 to 50 gsm.

35. A pliable sheet material of claim 30, wherein said tear resistant material is hessian.

36. A pliable sheet material of claim 35, wherein said hessian is from 6 to 8 ounces/square yard hessian.

37. A mulch, seed or like mat comprising:
a first ply of paper;
a second ply of paper; and
a matrix of paper shreds interposed between, yet adhering to, each of said plies, wherein there is included a mesh or woven material.

38. A mat of claim 37, wherein the mesh or woven material is biodegradable.

39. A mat of claim 37, wherein (A) the mesh or woven material, and (B) the adhesive and/or the patterning of the adhesive affixing the mesh or woven material to the paper, allows water passage.

40. A ground covering of at least substantially juxtaposed lengths of water penetrable webs of a pliable sheet material, each web edgewise being attached (with or without any overlap) to a juxtaposed web, wherein each web includes a wet strength providing layer of a mesh or woven material whether co-extensively of the web or not, and wherein the, or a, paper layer of the pliable sheet material, as a matrix flanking layer, has a matrix of paper shreds, or other shred-like material, adhered thereto or adhered both internally thereto and to another matrix flanking layer.

41. The use of tear resistant material as an internally and/or externally applied and adhered layer of and/or to a paper based sheet assembly having between paper sheets a shredded paper material matrix.

42. A pliable sheet material, as or for a horticultural ground covering, of paper shreds, at least to some extent mutually bonded, between water porous paper or paper including liners; wherein at least one liner has at least one layer of a coating material over and/or at least one layer of sheet material affixed externally thereof, such coating and/or layer to improve, or having the capability to improve, tear resistance and/or reflectivity to horticultural plants.

43. A ground covering of at least substantially juxtaposed lengths of water penetrable webs of a pliable sheet material, each web edgewise being attached (with or without any overlap) to a juxtaposed web, wherein each web has a wet strength providing layer of a mesh material, or woven material or non-woven material;
and wherein the, or a, paper layer of the pliable sheet material, as a matrix flanking layer, has a matrix of paper shreds, or other shred-like material, adhered thereto or adhered both internally thereto and to another matrix flanking layer.

44. A ground covering of claim 43, wherein the mesh material, woven material or non-woven material is porous to water.

45. A ground covering of claim 43, wherein the mesh material, woven material or non-woven material is affixed externally of and to a paper layer.

46. A ground covering of claim 43, wherein the mesh material, woven material or non-woven material is hessian or a plastics material.

47. A ground covering of claim 45, wherein the mesh material, woven material or non-woven material is coextensive with its paper layer.

48. A ground covering of claim 43, wherein the mesh material, woven material or non-woven material has been affixed subsequently to the matrix of shreds being interposed and adhered to spaced flanking layers of paper.
